(19) United States
(12) Patent Application Publication
(10) Pub. No.: US 2011/0282090 A1
(43) Pub. Date: Nov. 17, 2011

(54) PROCESS FOR PREPARING BORONIC ACIDS AND ESTERS IN THE PRESENCE OF MAGNESIUM METAL

(75) Inventors: Isabel Dunach, Villeneuve-Loubet (FR); Sandra Olivero, Nice (FR); Christine Pintaric, L'escarene (FR)

(73) Assignee: Universite De Nice Sophia Antipolis, Nice Cedex 2 (FR)

(21) Appl. No.: 13/128,612

(22) PCT Filed: Nov. 2, 2009
(86) PCT No.: PCT/FR2009/052106

§ 371 Date: Aug. 3, 2011

(30) Foreign Application Priority Data
Nov. 17, 2008 (FR) 0806420

(51) Int. Cl. C07F 5/04; C07F 5/02

(52) U.S. Cl. 558/288; 562/7

(57) ABSTRACT

The present invention relates to the process for preparing a boronic acid or ester chemically, in which an aromatic compound is reacted with a boronating agent, in the presence of magnesium metal (Mg⁰). The invention also relates to the boronic acids or esters that can be obtained by means of this process and to the use thereof for example as a synthesis intermediate, in the Suzuki reaction, in the pharmaceutical or alternatively electronics field.

### TECHNICAL FIELD

The present invention relates to the process for chemically preparing a boronic acid or boronic ester in which an aromatic compound is reacted with a borating agent, in the presence of magnesium metal (Mg⁰).

The invention also relates to the boronic acids or esters that can be obtained by this process and their use, for example as synthesis intermediate, in the Suzuki reaction, in the pharmaceutical, or alternatively, electronic field.

In the following description, the references between brackets [ ] refer to the list of references presented at the end of this text.

### RELATED ART

The boronic acids and esters are used in many fields. Owing to their various properties, in particular their stability and ease of handling, they are a particularly interesting class of reaction intermediates. Moreover, due to their low toxicity and their ultimate degradation as boric acid, these boronic acids are qualified as “green” compounds [1]. They are particularly adapted to the field of medical and pharmaceutical applications.

The growing interest relating to the boronic acids and esters resides, in particular, in their broad use in the coupling reactions between hydrocarbon radicals in the presence of a catalyst containing a metal, leading to the creation of the carbon-carbon bonds. Among the coupling reactions the Suzuki reaction can be regarded as the most used. It makes it possible to obtain symmetrical or dissymmetrical diaryl derivatives [2, 3]. The Suzuki coupling reaction has been described with regard to many derivatives with several applications and is carried out under soft and various conditions.

One of the major problems in this field resides in the preparation of the precursors of this coupling, the boronic acids or esters. The preparation most often used to obtain boronic acids and esters is carried out in two stages:
in a first stage, an organometal species (that is to say a Grignard or lithium type) is prepared from an organic halide in a solvent which may be for example an anhydrous ethereal solvent,
which is followed by the addition of the borating agent, generally a trialkyl borate, B (OR)₃, at low temperature (for example at −78° C.) [4, 5]. Other processes for preparing boronic esters require transition metal complexes, generally of Pd or Rh.

In the particular case of benzylboronic acids and esters, the typical processes describing their preparation are mainly:
the process by borating hydrocarbons or benzylic halides, and
the process by functionalizing borated derivatives (using halogenoborate, by homologation i.e. addition of —CH₂— between the phenyl group and the boron function, etc).

The use of an organometallic compound of magnesium or lithium was not described with the above mentioned benzylic substrates.

The preparation process through benzylic hydrocarbon and halide boration require direct functionalization either of the chlorinated or brominated benzylic halides, or of the hydrocarbons (such as toluene) which undergo a boration of the C—H bond in benzyl position.

In 2002, the synthesis of benzylboronic esters from benzylic halides with pinacolborane using catalytic systems containing palladium, such as PdCl₂(PPh₃)₂/i-Pr₂NEt [11] or Pd(PPh₃)₄/K₂CO_{3 [}12] has been described. The bis(pinacolyl) diboron (FIG. 1, compound C) was also used as borating agent [13]

The boration of the C—H bond in the benzylic position was observed during functionalization in toluene by pinacolborane, in the presence of a rhodium-based catalyst at 140° C. [14, 15].

A catalytic system of Pd/C allows a selective boration of the C—H bond of alkylbenzenes by the bis(pinacolyl)diboron or the pinacolborane [16].

Owing to the use of Pd complexes, these processes are expensive. In addition, upon implementing these processes, in particular on an industrial scale (scale-up), operational problems may arise.

While the industrial environment is in need of boronic acids and esters, these processes are not very adapted thereto. For example, the treatment of the reagents in anhydrous solvents at −78° C. is delicate and with the use of Pd or Rh complexes the cost of the processes increases substantially. In addition, with some metals, such as for example lithium, in addition to the high cost, the scale-up may pose operational problems.

Since 1999, the inventors developed new electrochemical ways relating to the boration of aryl [6, 7, 8] and benzyl [9] halides operating at room temperature in the presence of a magnesium anode. BASF was also interested in this electrochemical methodology [10]. However, the implementation of this technology is not always easy and is still expensive. Moreover, the electrochemical [9] recycling of the Me ions is difficult.

Thus, there exists a real need for a process for chemically preparing boronic acid or ester mitigating the defects, disadvantages and obstacles of the prior art.

In particular there exists a real need for a process for chemically preparing boronic acid or ester of which operating conditions are soft, a process which makes it possible to reduce the costs in particular by implementing an effective catalyst, widely available and not expensive.

Moreover, there exists a need for a chemical process hardly toxic, hardly polluting and compatible with a sustainable development and a clean chemistry.

### DESCRIPTION OF THE INVENTION

The aim of the present invention is precisely to meet this requirement by providing a process for preparing a boronic acid or ester of formula (I):

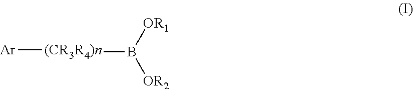

in which

Ar represents a mono- or poly-cyclic, fused or non-fused, aryl radical including 6 to 27 carbon atoms or a mono- or poly-cyclic, fused or non-fused, heteroaryl radical including 6 to 20 carbon atoms, said aryl or heteroaryl radical being optionally substituted by one or more groups independently selected from the group including (C₁-C₁₀) alkyl, (C₂-C₁₀) alkene, (C₂-C₁₀)alkyne, (C₃-C₁₀)cycloalkyl, (C₁-C₁₀)heteroalkyl, (C₁-C₁₀)haloalkyl, (C₆-C₁₂) aryl, F, Cl, Br, I, —N0₂, —CN, —CF₃, —CH₂CF₃, —OH, —CH₂OH, —CH₂CH₂OH, —NH₂, —CH₂NH₂, —NHCHO, —COOH, —CONH₂, —SO₃H, —O(SO)₂—R₅ where R₅ is (C₁-C₁₀) alkyl, —PO₃H, —PO₃R₁,
n=0 to 1;
R₁, R₂, R₃ and R₄, same or different, represent a hydrogen atom, a (C₁-C₁₀)alkyl group, a mono- or poly-cyclic, fused or non-fused, aryl radical including 6 to 27 carbon atoms, a mono- or poly-cyclic, fused or non-fused, heteroaryl radical including 6 to 20 carbon atoms, said radical and group being optionally substituted by one or more groups independently selected from the group including (C₁-C₁₀) alkyl, (C₁-C₁₀) alkoxy, (C₂-C₁₀) alkene, (C₂-C₁₀) alkyne, (C₃-C₁₀)cycloalkyl, (C₁-C₁₀)heteroalkyl, (C₁-C₁₀)haloalkyl, (C₆-C₁₂)aryl, F, Cl, Br, I, NO₂, —CN, —CF₃, —CH₂CF₃, —OH, —CH₂OH, —CH₂CH₂OH, —NH₂—CH₂NH₂, —NHCHO, —COOH, —CONH₂, —SO₃H, —O(SO)₂—R₅ where R₅ is (C₁-C₁₀)alkyl, —PO₃H, —PO₃R₁; or
R₁ and R₂ form with the oxygen atoms to which they are bonded, a 5 or 6 links ring optionally substituted by one or more groups independently selected from the group including a (C₁-C₁₀)alkyl group, a mono- or poly-cyclic aryl radical, fused or non-fused, including 6 to 27 carbon atoms, a mono- or poly-cyclic heteroaryl radical, fused or non-fused, including 6 to 20 carbon atoms said radical and group being substituted by one or more groups independently selected from the group including (C₁-C₁₀) alkyl, (C₂-C₁₀)alkene, (C₂-C₁₀)alkyne, (C₃-C₁₀)cycloalkyl, (C₁-C₁₀)heteroalkyl, (C₁-C₁₀)haloalkyl, (C₆-C₁₂)aryl, F, Cl, Br, I, —N0₂, —CN, —CF₃, —CH₂CF₃, —OH, —CH₂OH, —CH₂CH₂OH, —NH₂, —CH₂NH₂, —NHCHO, —COOH, —CONH₂, —SO₃H, —O(SO)₂—R₅ where R₅ is (C₁-C₁₀)alkyl, —PO₃H, —PO₃R₁;

in which a compound of formula (II):

Ar—(CR₃R₄)n-X (II)

in which Ar, R₃, R₄ and n are such as previously defined and X is selected from the group including F, Cl, Br, I, —CF₃, —O(SO)₂CF₃, —O(SO)₂—R₅ with R₅ being (C₁-C₁₀)alkyl;

is reacted with a borating agent and in the presence of magnesium metal (Mg⁰) used in an amount from 0.01 to 1 equivalent, with respect to the amount of the compound of formula (II).

Unexpectedly, the use of the magnesium metal proved to be particularly advantageous. Indeed, because of the effectiveness of the magnesium metal, the boronic acids and esters of formula (I) are obtained chemically, with a good yield and a good selectivity. The process is carried out under soft operating conditions. In addition, owing to the relatively low price of magnesium metal, to its abundance and its lack of toxicity, the process of the invention is a process of choice in many cases.

Moreover, contrary to the Mg²⁺ ions, the recycling of Mg⁰ proved to be particularly easy in some cases.

Contrary to the electrochemical processes of the related art, the process of the invention is a chemical process. Within the framework of the present invention, the chemical process is a process in which the modification of the composition of the molecules is made by chemical reactions which are not produced by electric power.

In particular, in the process of the invention, the chemical reaction between the compound of formula (II) and the borating agent in the presence of Mg⁰ which leads to obtaining a boronic acid or ester of formula (I) is a coupling reaction.

Within the meaning of the present invention, what is meant by “alkyl”, is a saturated, optionally substituted, linear or ramified carbon radical, including from 1 to 10 carbon atoms, for example 1 to 8 carbon atoms, for example 1 to 6 carbon atoms. For example, an alkyl radical may be a methyl, ethyl, n-propyl, isopropyl, n-butyl, sec-butyl, isobutyl, tert-butyl, n-pentyl, sec-pentyl, isopentyl, tert-pentyl, n-hexyl, sec-hexyl radical or like radicals.

Within the meaning of the present invention, what is meant by “alkene”, is a cyclic or acyclic, linear or ramified, unsaturated hydrocarbon radical, including at least a double carbon-carbon bond. The alkenyl radical may comprise from 2 to 10 carbon atoms, more particularly from 2 to 8 carbon atoms, even more particularly from 2 to 6 carbon atoms. For example, an alkenyl radical may be an allyl, ethenyl, propenyl, butenyl, 1-methyl-2-buten-1-yl radical or like radicals.

The term “alkyne” designates a cyclic or acyclic, linear or ramified, unsaturated hydrocarbon radical, including at least a triple carbon-carbon bond. The alkynyl radical may comprise from 2 to 10 carbon atoms, more particularly from 1 to 8 carbon atoms, even more particularly from 2 to 6 carbon atoms. For example, an alkynyl radical may be an ethynyl, 2-propynyl (propargyl), 1-propynyl radical or like radicals.

Within the meaning of the present invention, what is meant by “aryl” is an aromatic system including at least a ring satisfying the aromaticity Hückel's rule. Said aryl is optionally substituted and may comprise from 6 to 27 carbon atoms, in particular from 6 to 14 carbon atoms, more particularly from 6 to 12 carbon atoms. For example, an aryl radical may be a phenyl, naphthyl, tetrahydronaphthyl, indanyl, indenyl group or like radicals.

Within the meaning of the present invention, what is meant by “heteroaryl” is a system including at least an aromatic ring of 6 to 20 carbon atoms, and at least a heteroatom selected from the group including, in particular, sulfur, oxygen, nitrogen. Said heteroaryl may be substituted. For example, a heteroaryl radical may be a pyridyl, pyrazinyl, pyrimidinyl, pyrrolyl, pyrazolyl, imidazolyl, thiazolyl, oxazolyl, isooxazolyl, thiadiazolyl, oxadiazolyl, thiophenyl, furanyl, quinolinyl, isoquinolinyl radical, and like radicals. Within the meaning of the present invention, what is meant by “cycloalkyl”, is a cyclic, saturated or unsaturated, optionally substituted, carbon radical, which can comprise 3 to 10 carbon atoms. For example, cyclopropyl, cyclobutyl, cyclopentyl, cyclohexyl, cycloheptyl, cyclooctyl, 2-methylcyclobutyl, 2,3-dimethyl-cyclobutyl, 4-methylcyclobutyl, 3-cyclopentylpropyl may be mentioned.

Within the meaning of the present invention, what is meant by “haloalkyl”, is an alkyl radical such as previously defined, said alkyl system including at least a halogen chosen from the group including fluorine, chlorine, bromine, iodine.

Within the meaning of the present invention, what is meant by “heteroalkyl”, is an alkyl radical such as previously defined, said alkyl system including at least a heteroatom, in particular, selected from the group including sulfur, oxygen, nitrogen, phosphorus.

Within the meaning of the present invention, what is meant by “heterocycle”, is a saturated or unsaturated, optionally substituted cyclic carbon radical including at least one heteroatom, and which may comprise from 3 to 20 carbon atoms, preferably 5 to 20 carbon atoms, preferably 5 to 10 carbon atoms. For example, the heteroatom may be selected from the group including sulfur, oxygen, nitrogen, phosphorus. For example, a heterocyclic radical may be a pyrrolidinyl, pyrazolinyl, pyrazolidinyl, imidazolinyl, imidazolidinyl, piperidinyl, piperazinyl, oxazolidinyl, isoxazolidinyl, morpholinyl, thiazolidinyl, isothiazolidinyl, or tetrahydrofuryl group.

Within the meaning of the present invention, what is meant by “alkoxy”, “aryloxy”, “heteroalkoxy” and “heteroaryloxy”, is respectively, an alkyl, aryl, heteroalkyl and heteroaryl radical bonded to an oxygen atom. For example, an alkoxy radical may be a methoxy, ethoxy, propoxy, isopropoxy, n-butoxy, tert-butoxy, neopentoxy, n-hexoxy radical or a like radical.

The term “substituted” denotes for example the replacement of a hydrogen atom in a structure given by a group such as previously defined. When more than one position in a given structure may be substituted, the substituents may be the same or different at each position.

According to a particular embodiment of the invention, the compounds of formula (II) are those previously defined in which X is selected from the group including F, Cl, Br, I, —SO₃CF₃. More particularly, X may be Cl, Br.

For example, the compounds of formula (II) may be selected from the group including:
benzyl bromide or chloride; 4-methylbenzyl bromide or chloride; 4-methoxybenzyl bromide or chloride;
2-methylbenzyl bromide; 3,5-dimethylbenzyl bromide; 4-tertbutylbenzyl bromide; (2-bromoethyl)benzene; 4-chlorobenzyl bromide; 4-bromobenzyl bromide.
4-ethylbenzene iodide; 2-methylbenzene bromide; 4-butylbenzene bromide; 4-methylnaphthalene bromide; 3,4-difluorobenzene bromide.

The process of the invention is carried out by means of a borating agent.

The borating agent may be for example of formula (III):

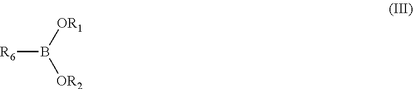

in which R₁ and R₂ are such as previously defined and R₆ represents a hydrogen atom. The borating agent of formula (III) may be selected from the group including pinacolborane (HBpin), catecholborane (HBcat).

The borating agent may also be, for example, of formula (IV):

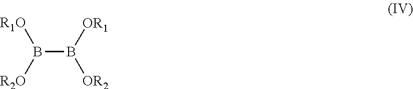

in which R₁ and R₂ are such as previously defined. It may be selected for example from the group including bis(pinacolyl)diboron (pinB-Bpin). The borating agent may still be for example of formula (V):

BxHyQz (V)

in which
Q is an alkaline metal selected from the group including Li, Na, K, or Q is R₁ such as previously defined,
X is an integer ranging between 1 and 10,
y is an integer ranging between 3 and 14, and
Z=0 to 3,

given that when Z=0, the boron hydride is optionally in the form of a complex.

What is meant by the term “complex” is the entity obtained during the reaction between BH₃ which is a Lewis acid (having vacant orbitals) and an organic molecule which is a Lewis base (having one or more non-bonding electro doublets). By way of an example of an organic molecule which can be regarded as a Lewis base, for example THF, S(CH₃)₂, pyridine, morpholine may be mentioned.

The borating agent of formula (V) may be selected from the group including BH₃.S (CH₃)₂, BH₃.THF, NaBH₄.

The borating agent may be used in a stoechiometric amount with respect to the amount of the compound of formula (II) or in excess with respect thereto.

The terms “stoechiometric amount” and “in excess” are broadly used terms and their significance is quite clear to the man skilled in the art.

The term “stoechiometric amount” means a molar ratio of 1 to 1 among the reagents used. For example, in the process of the invention, the molar ratio of the compound of formula (II) and that of the borating agent may be from 1 to 1.

The term “in excess” means that one of the reagents (for example the borating agent) is present at a molar amount higher than 1, with respect to the other reagent (for example the compound of formula (II)). Under these conditions, the reaction medium always contains, at the end of the reaction, the desired product and a certain amount of the reagent in excess. Of course a man skilled in the art will be able to choose the amount of reagent “in excess” such that the presence of said reagent in excess does not disturb the later stages of the process. In general, the advantage of using one of the reagents in excess is to obtain a better yield of the desired product.

As previously indicated, the process of the invention is carried out in the presence of magnesium metal (Mg⁰). Magnesium metal (Mg⁰) may be for example in the form of turnings, powder, bar or in any other form. These various forms of Mg⁰ are commercially available products and well-known to the skilled person.

Magnesium metal (Mg⁰) may be used as is without activation. It may also be activated, by any processing known to the skilled person, allowing the activation of magnesium metal such as for example through a processing using an acid or through an ultrasound processing or any other way adapted to the activation of magnesium metal. Activation may be carried out before the introduction of magnesium metal into the reaction medium. It may also be carried out in situ [17, 18, 19].

Magnesium metal (Mg⁰) may be used in an amount from 0.01 to 1 equivalent, for example, from 0.02 to 0.5 equivalent, with respect to the amount of the compound of formula (II).

For example, the amount of magnesium used may still be from 0.01 to 0.2 equivalent with respect to the amount of the compound of formula (II).

In an embodiment of the invention, when in the compound of formula (II) n=0, the amount of magnesium metal (Mg⁰) used can be of 1 equivalent with respect to the amount of the compound of formula (II).

In another embodiment of the invention, when in the compound of formula (II) n=1, the amount of magnesium metal (Mg⁰) used may be from 0.01 to 0.2 equivalent with respect to the amount of the compound of formula (II).

According to the invention, the reaction between the compound of formula (II) and the borating agent, may take place in one organic solvent or a mixture of organic solvents in the presence of a base.

The bases being appropriate to the process of the invention, may be selected for example from the group including:
NR(R)₃ where R, same or different, may be selected from the group including an alkyl group such as previously defined, a heteroaryl group such as previously defined;
RO⁻M⁺ where R is an alkyl group such as previously defined and M is an alkaline metal selected from the group including for example, lithium, sodium, potassium.

The base can be selected from the group including for example triethylamine (NEt₃), potassium tert-butylate (t-BuOK), 2,6-di-tert-butylpyridine, tributylamine, tripropylamine, triisopropylamine

In a particular embodiment, the base is triethylamine. The base may be used at a stoechiometric amount. It may also be used in excess with respect to the amount of the compound of formula (II). For example, the base may be used in an amount from 1 to 5 equivalents with respect to the compound of formula (II).

The reaction between the compound of formula (II) and the borating agent takes place in a solvent or a mixture of solvents.

As the solvent, for example ethers in which the oxygen atom is bonded to two groups or radicals, same or different, selected from the group including the alkyl, cycloalkyl, aryl, radicals such as previously defined may be mentioned. The ethers may be selected for example from the group including dimethyl oxide (methoxymethane), dimethoxyethane, diethoxyethane, ethyl and methyl oxide (methoxyethane), diethyl oxide (diethyl ether or ethoxyethane), ethyl and 2-methylethyl oxide (2-ethoxypropane), tetrahydrofuran (THF), tetrahydropyran (THP), dioxane, methoxybenzene (anisole).

The solvent may still be an amide chosen from the group including acetamide, formamide, N,N-dimethylformamide.

The solvent may be a nitrile selected from the group including acetonitrile.

According to a particular embodiment of the invention, the solvent is selected from the group including diethyl ether, tetrahydrofuran (THF), methoxybenzene (anisole), N,N-dimethylformamide (DMF), acetonitrile or a mixture thereof.

Compared to the known processes, the process is carried out under soft operating conditions. Thus, the reaction between the compound (II) and the borating agent may take place in a broad temperature range. For example, it may take place at a temperature from 0° C. to the reflux temperature of the solvent or mixture of solvents.

The duration of the reaction may range from 1 to 48 hours, for example from 1 to 15 hours.

Another aspect of the invention relates to a boronic acid or ester of formula (I) that can be obtained by the process of the invention.

Another object of the invention is the use of a boronic acid or ester of formula (I) that can be obtained by the process of the invention as synthesis intermediate in particular in the coupling reactions between hydrocarbon radicals.

It also relates to the use of an acid or an ester of formula (I) that can be obtained by the process of the invention in the Suzuki reaction, or alternatively in the pharmaceutical or electronic field.

Other advantages will become more apparent to the skilled person from the reading of the examples below, illustrated by the annexed figures, given only on an illustrative basis.

### BRIEF DESCRIPTION OF THE FIGURES

FIG. 1 represents borating agents: A represents pinacolborane (HBpin), B represents catecholborane (HBcat) and C represents bis(pinacolyl)diboron (pinB-Bpin).

FIG. 2 represents the study of stability of boronic esters of samples 1, 1′, 2 and 2′ during weeks 1 to 10. % refers to the percentage in the products detected in the samples by gas chromatography and t refers to the duration of the analyses expressed in weeks.

FIG. 3 represents the study of stability of boronic esters 3, 3′, 4, 4′ during weeks 1 to 10. % P refers to the percentage in the products detected in the samples by gas chromatography and t refers to the duration of the analyses expressed in weeks.

FIG. 4 represents the study of stability of boronic esters 5, 5′, 6, 7 during weeks 1 to 10. % P refers to the percentage in the products detected in the samples by gas chromatography and t refers to the duration of the analyses expressed in weeks.

FIG. 5 represents the study of stability of boronic esters 11, 11′, 12, 12′ during weeks 1 to 10. % P refers to the percentage in the products detected in the samples by gas chromatography and t refers to the duration of the analyses expressed in weeks.

FIG. 6 represents the study of stability of boronic esters 13, 13′, 14, 14′ during weeks 1 to 10. % P refers to the percentage in the products detected in the samples by gas chromatography and t refers to the duration of the analyses expressed in weeks.

FIG. 7 represents the study of stability of boronic esters 15, 15, 16, 17 during weeks 1 to 10. % P refers to the percentage in the products detected in the samples by gas chromatography and t refers to the duration of the analyses expressed in weeks.

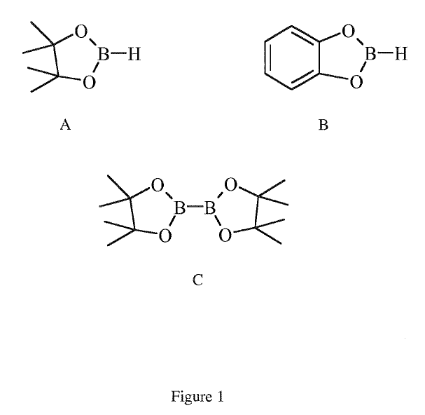

### EXAMPLES

### Solvents

The solvents used exhibit a purity higher than 99.5%, or are of a “pure solvent for synthesis” grade. For the reactions requiring anhydrous conditions, the solvents were dried and distilled according to the protocols described in the literature. For each distilled solvent (unless otherwise stated), the distilling head accounting for 10% by volume is withdrawn and the distilling heart is recovered under nitrogen outflow in Schlenk type flasks. The solvents are then preserved in nitrogen on an activated molecular sieve type 4 Å and shielded from light.
Dichloromethane (CH₂Cl₂): dichloromethane is stirred for hours at room temperature in the presence of calcium chloride in a Schlenk type flask topped by a distillation assembly under inert atmosphere. The mixture is then distilled by heating at atmospheric pressure, (boiling point_{(76o mm Hg)}=40° C.)
N,N-dimethylformamide (DMF): DMF is distilled under reduced pressure. It is initially dried over calcium hydride (20 grams per liter) at room temperature for 18 hours. Then, the mixture is distilled by heating under reduced pressure, (boiling point_{(50mm Hg)}=55° C.)
Acetonitrile (MeCN): acetonitrile is dried over calcium hydride (20 grams per liter) at room temperature for 15 hours. Then, the mixture is distilled by heating at atmospheric pressure, (boiling point_{(760 mm Hg)}=82° C.)
Tetrahydrofuran (THF): THF is first stirred at room temperature for 18 hours on yarn metal sodium in the presence of benzophenone (blue-violet solution). THF is then distilled by heating at atmospheric pressure, (boiling point_{(76o mm Hg)}=66° C.
1,2-diethoxyethane (DEE): DEE is first stirred at room temperature on yarn metal sodium in the presence of benzophenone (blue-violet solution). DEE is then distilled by heating at atmospheric pressure, (boiling point_{(760 mm Hg)}=121° C.

The solvents used for the extractions—diethyl ether, n-pentane, n-hexane—are used without purification.

Nuclear Magnetic Resonance (NMR)

Proton, carbon 13, fluorine 19 NMR spectra were recorded on a BRUKER AC 200 apparatus for analyses at 200 MHz, in deuterated chloroform (unless otherwise stated) and at room temperature.

The chemical shifts d are expressed positively towards the weak fields in part per million (ppm), with respect to tetramethylsilane (d=0). The coupling constants J are expressed in Hertz (Hz).

Mass Spectrometry (MS)

The mass spectra were obtained by gas chromatography coupled to the mass spectrometry (GC/MS) by means of a chromatograph HP 5890A (HP1 column, polydimethylsiloxane, 50 m·0.20 mm i.d., 0.33 mm film thickness) provided with a HP 5971 mass selective detector (electronic impacts at 70 eV) or a Thermo Quest TRACES GC 2000 chromatograph (DBTMS column, 15 m×0.20 mm i.d., 0.33 mm film thickness) provided with a mass selective detector Automass III multi (electronic impacts at 70 eV).

Gas Chromatography (GC)

The gas chromatography (GC) analyses were carried out on several Varian Star 3400 and Varian CP 3380 chromatographs, provided with capillary columns Chrompack (fused silica WCOT, 25 m×0.25 mm i.d. 0.25 mm film thickness).

### I. Preparation of Boronic Esters in the Presence of Magnesium Turnings

Examples 1 to 14 were carried out with magnesium turnings.

magnesium turnings (99.8% pure) from Prolabo were used. These turnings are pickled beforehand. To this end, the turnings are disposed into a beaker and acid water (HCI 0.1 M) is added using a Pasteur pipette. The suspension obtained must be stirred up for activating the magnesium homogeneously. The obtained “solution” is filtered very quickly and the turnings are rinsed with neutral water then acid water (HCI 0.1 M) is added further. The turnings are again filtered very quickly. They are rinsed with neutral water, with acetone and placed in a drying oven for drying.

### Example 1

### Preparation of pinacol ester of 4-ethylphenylboronic acid

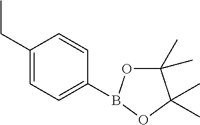

In a 2 necks Schlenk type flask, provided with a magnetic stirring bar and topped by a coolant, 4-ethylbenzene iodide (0.232 g, 1 mmol), pinacolborane (0.128 g, 1 mmol) and triethylamine (59 mg, 1 mmol) are added to 10 ml of a distilled THF solution containing magnesium turnings (24 mg, 1 mmol). The reactive mixture is stirred for approximately 15 hours at THF reflux.

At the end of the reaction, the crude reaction product is hydrolyzed by 20 ml of neutral water and extracted by diethyl ether (3×40 ml). The joined organic phases are washed by 2×50 ml of neutral water then dried on MgSO₄. After solvent evaporation, the obtained yield is of 96% with a total conversion of the starting iodide (yield/conversion of 96%). The resulting boronic ester is analyzed by GC, NMR ¹H and ¹³C and GC/MS.

### Characterizations:

NMR ¹H, 7.74 (2H, D, 3 Hz); 7.22 (2H, D, 3 Hz); 2.66 (2H, Q, 3 Hz); 1.34 (12H, s); 1.24 (3H, T, 3 Hz).

NMR ¹³C, 146.68; 133.87; 127.23; 126.31; 82.58; 28.08; 23.82; 14.42.

Mass spectrometry: 232-231 (M+, 6-2%); 217-216 (8-2%); 147 (19%); 146-145 (71-15%); 134 (17%); 133 (100%); 132-131 (63-21%); 118 (18%); 117 (51%); 116-115 (17-4%); 105 (18%); 104 (10%); 91 (11%); 85 (14%); 77-76 (9-2%).

Ultimate Analyses:

calculated %: C: 72.44%; H: 9.12%; B: 4.66%.

obtained %: C: 70.22%; H: 9.25%; b: 4.39%.

### Example 2

### Preparation of pinacol ester of 3,4-difluorophenylboronic acid

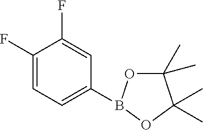

In a 2 necks Schlenk type flask, provided with a magnetic stirring bar and topped by a coolant, 3,4-difluorobenzene bromide (0.193 g, 1 mmol), pinacolborane (0.128 g, 1 mmol) and triethylamine (59 mg, 1 mmol) are added to 10 ml of a distilled THF solution containing magnesium turnings (24 mg, 1 mmol). The reactive mixture is stirred for approximately 15 hours at THF reflux.

At the end of the reaction, the crude reaction product is hydrolyzed by 20 ml of neutral water and is extracted by diethyl ether (3×40 ml). The joined organic phases are washed by 2×50 ml of neutral water then dried on MgSO₄. After solvent evaporation, the obtained yield is of 93% with a conversion of 98% of the starting bromide (yield/conversion of 95%). The obtained boronic ester is analyzed by GC, NMR ¹H and ¹³C and GC/MS.

### Characterizations:

NMR ¹H: 7.6-7.5 (2H, m); 7.2-7.1 (1H, m); 1.3 (12H, s).

NMR ¹³C, 149.5; 131.1; 129.2; 117.5; 117; 82.7; 21.4.

Mass spectrometry: 240-239 (M+, 14-6%); 226 (16%); 225 (56%); 224 (16%); 155 (12%); 154 (58%); 142 (12%); 141 (90%); 140 (56%); 139 (13%); 95 (12%); 94 (19%); 85 (58%); 75 (34%); 74 (14%); 69 (23%); 63 (17%); 59 (78%); 58 (100%); 56 (12%); 55 (15%).

### Example 3

### Preparation of pinacol ester of 2-methylphenylboronic acid

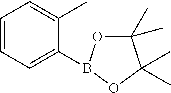

In a 2 necks Schlenk type flask, provided with a magnetic stirring bar and topped by a coolant, 2-methylbenzene bromide (0.171 g, 1 mmol), pinacolborane (0.128 g, 1 mmol) and triethylamine (59 mg, 1 mmol) are added to 10 ml of a distilled THF solution containing magnesium turnings (24 mg, 1 mmol). The reactive mixture is stirred for approximately 15 hours at THF reflux.

At the end of the reaction, the crude reaction product is hydrolyzed by 20 ml of neutral water and is extracted by diethyl ether (3×40 ml). The joined organic phases are washed by 2×50 ml of neutral water then dried on MgSO₄. After solvent evaporation, the obtained yield is of 91% with a conversion of 94% of the starting bromide (yield/conversion of 97%). The resulting boronic ester is analyzed by GC, NMR ¹H and C and GC/MS.

### Characterizations:

NMR ¹H, 7.1 (4H, m); 2.4 (3H, s); 1.3 (12H, s).

NMR ¹³C, 140.1; 133.8; 129; 129.1; 128.7; 125.8; 83.2; 21.4; 21.1.

Mass spectrometry: 218-217 (M+, 9-3%); 203 (13%); 161 (28%); 160 (12%); 120 (13%); 119 (99%); 118 (100%); 117 (59%); 116 (13%); 92 (13%); 91 (49%); 90 (13%); 85 (29%); 77 (15%); 65-64 (20-5%); 59 (27%); 58 (12%); 57 (19%); 55 (11%).

### Example 4

### Preparation of pinacol ester of 3,5-dimethylbenzylboronic acid

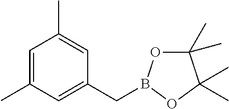

In a 2 necks Schlenk type flask, provided with a magnetic stirring bar and topped by a coolant, 3,5-dimethylbenzyl bromide (0.198 g, 1 mmol), pinacolborane (0.128 g, 1 mmol) and triethylamine (59 mg, 1 mmol) are added to 10 ml of a distilled THF solution containing magnesium turnings (24 mg, 1 mmol). The reactive mixture is stirred for approximately 15 hours at THF reflux.

At the end of the reaction, the crude reaction product is hydrolyzed by 20 ml of neutral water and is extracted by diethyl ether (3×40 ml). The joined organic phases are washed by 2×50 ml of neutral water then dried on MgSO₄. After solvent evaporation, the obtained yield is of 80% with a total conversion of 94% of the starting bromide (yield/conversion of 80%). The resulting boronic ester is analyzed by GC, NMR ¹H and ¹³C and GC/MS.

### Characterizations:

NMR ¹H, 6.7 (3H, s); 2.4 (6H, s); 1.8 (2H, s); 1.3 (12H, s).

NMR ¹³C, 139.7; 138.2; 127.9; 83.7; 34.2; 24.9; 21.7.

Mass spectrometry: 246-245 (M+, 20-6%); 160 (17%); 147 (29%); 146 (77%); 145 (40%); 131 (24%); 120 (35%); 119 (93%); 118 (16%); 117 (14%); 115 (14%); 106 (15%); 105 (65%); 104 (20%); 103 (19%); 91 (39%); 86 (11%); 85 (82%); 84 (36%); 83 (100%); 79 (14%); 78 (14%); 77 (28%); 59 (28%); 58 (10%); 57 (18%); 55 (19%).

### Example 5

### Preparation of pinacol ester of 4-methylbenzylboronic acid

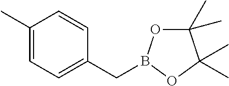

In a 2 necks Schlenk type flask, provided with a magnetic stirring bar and topped by a coolant, 4-methylbenzyl bromide (0.185 g, 1 mmol), pinacolborane (0.128 g, 1 mmol) and triethylamine (59 mg, 1 mmol) are added to 10 ml of a distilled THF solution containing magnesium turnings (24 mg, 1 mmol). The reactive mixture is stirred for approximately 24 hours at room temperature.

At the end of the reaction, the crude reaction product is hydrolyzed by 20 ml of neutral water and is extracted by diethyl ether (3×40 ml). The joined organic phases are washed by 2×50 ml of neutral water then dried on MgSO₄. After solvent evaporation, the obtained yield is of 63% with a conversion of 90% of the starting bromide (yield/conversion of 70%). The obtained boronic ester is analyzed by GC, NMR ¹H and ¹³C and GC/MS.

### Characterizations

NMR ¹H, 7.1 (4H, s); 2.29 (3H, s); 2.26 (2H, s); 1.2 (12H, s).

NMR ¹³C, 134.6; 133.1; 127.8; 82.3; 33.7; 24.2; 23.7.

Mass spectrometry: 232-231 (M+, 65-19%); 217 (29%); 174 (16%); 146 (56%); 133 (41%); 132 (89%); 131 (37%); 117 (15%); 106 (28%); 105-104 (100-20%); 103 (16%); 92 (16%); 91 (64%); 86 (15%); 85 (83%); 84 (40%); 83 (93%); 82 (14%); 79 (22%); 78 (23%); 77-76 (38? 9%); 69 (21%); 67 (10%); 59 (34%); 57 (24%); 55 (26%); 53 (15%); 51 (15%).

### Examples 6

### Preparation of pinacol ester of benzylboronic acid

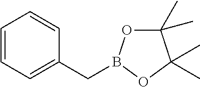

Magnesium turnings (2.4 mg, 0.1 mmol, 10 mol %) are introduced into a 2 necks Schlenk type flask, provided with a magnetic stirring bar and topped by a coolant, then 10 ml of distilled THF are added. Triethylamine (59 mg, 1 mmol) and pinacolborane (0.384 g, 3 mmol) are added therein. Benzyl bromide (0.171 g, 1 mmol) dissolved into 10 ml of distilled THF is then added drop by drop in the solution using a dropping funnel. Thereafter, the reactive mixture is stirred for approximately 15 hours at THF reflux (65° C.).

At the end of the reaction, the crude reaction product is hydrolyzed by 20 ml of neutral water and is extracted by diethyl ether (3×40 ml). The joined organic phases are washed by 2×50 ml of neutral water then dried on MgSO₄. After solvent evaporation, pinacol ester is obtained with a yield of 90% and a total conversion of the starting benzyl bromide (yield/conversion 90%). The obtained boronic ester is analyzed by GC, NMR ¹H and ¹³C and GC/MS.

### Characterizations

NMR ¹H: 7.3-7.1 (5H, m); 2.3 (2H, s); 1.2 (12H, s).

NMR ¹³C, 138.7; 129; 128.2; 124.8; 83.4; 33.6; 24.7.

Mass spectrometry: 218-217 (M+, 51-13%); 203-202 (25-7%); 132 (64%); 119 (39%); 118 (100%); 117 (43%); 92 (21%); 91 (57%); 85 (51%); 84 (14%); 83 (57%); 65 (14%); 59 (20%); 43 (30%); 41 (31%).

### Example 7

### Preparation of pinacol ester of bromobenzylboronic acid

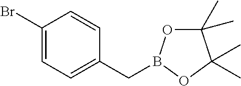

Magnesium turnings (2.4 mg, 0.1 mmol, 10 mol %) are introduced into a 2 necks Schlenk type flask, provided with a magnetic stirring bar and topped by a coolant then 10 ml of distilled THF are added. Triethylamine (59 mg, 1 mmol) and pinacolborane (0.384 g, 3 mmol) are introduced therein. 4-bromobenzyl bromide (0.251 g, 1 mmol) dissolved into 10 ml of distilled THF is then added drop by drop in the solution using a dropping funnel. Thereafter, the reactive mixture is stirred for approximately 15 hours THF reflux (65° C.).

At the end of the reaction, the crude reaction product is hydrolyzed by 20 ml of neutral water and is extracted by diethyl ether (3×40 ml). The joined organic phases are washed by 2×50 ml of neutral water then dried on MgSO₄. After solvent evaporation, the pinacol ester is obtained with a yield of 88% and a total conversion of the starting bromide (yield/conversion of 88%). The boronic ester is analyzed by GC, NMR ¹H and ¹³C and GC/MS.

### Characterizations

NMR ¹H, 7.3 (2H, D, 8 Hz); 6.9 (2H, D, 8 Hz); 1.8 (2H, s); 1.3 (2H, s).

NMR ¹³C: 139; 131.6; 131.3; 120.1; 83.3; 33.6; 21.3.

Mass spectrometry: 218-217 (m 79-80, 49-55%); 216 (22%); 212 (18%); 210 (20%); 199 (11%); 198 (29%); 197 (25%); 196 (30%); 195 (15%); 171 (17%); 169 (17%); 159 (10%); 118 (16%); 117 (69%); 116 (33%); 91 (23%); 90 (30%); 89 (28%); 86 (12%); 85 (81%); 84 (42%); 83 (100%); 82 (17%); 69 (11%); 67 (11%); 65 (18%); 63 (12%); 59 (36%); 58 (19%); 57 (34%); 56 (13%); 55 (22%); 54 (10%).

### Example 8

### Preparation of pinacol ester of 4-chlorobenzylboronic acid

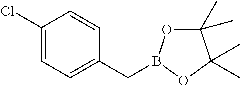

Magnesium turnings (2.4 mg, 0.1 mmol, 10 mol %) are introduced into a 2 necks Schlenk-type flask, provided with a magnetic stirring bar and topped by a coolant, then 10 ml of distilled THF are added. Triethylamine (59 mg, 1 mmol) and pinacolborane (0.384 g, 3 mmol) are introduced therein. 4-chlorobenzyl bromide (0.207 g, 1 mmol) dissolved into 10 ml of distilled THF is then added drop by drop in the solution using a dropping funnel. Thereafter, the reactive mixture is stirred for approximately 15 hours at THF reflux (65° C.).

At the end of the reaction, the crude reaction product is hydrolyzed by 20 ml of water neutral and extracted by diethyl ether (3×40 ml). The joined organic phases are washed by 2×ml of neutral water then dried on MgSO₄. After solvent evaporation, the pinacol ester is obtained with a yield of 90% at a total conversion of the starting bromide (yield/conversion of 90%). The resulting boronic ester is analyzed by GC, NMR ¹H and ¹³C and GC/MS.

### Characterizations

NMR ¹H: 7.2 (2H, D, 8 Hz); 6.9 (2H, D, 8 Hz); 1.9 (2H, s); 1.3 (12H, s).

NMR ¹³C: 138; 131.3; 130.5; 128.8; 83.8; 33.5; 21.4.

Mass spectrometry: 254-252 (M+, 1-4%); 127 (32%); 126 (20%); 125 (100%); 124 (20%); 63 (12%).

### Example 9

### Preparation of pinacol ester of phenylethylboronic acid

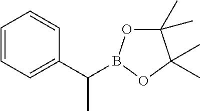

Magnesium turnings (2.4 mg, 0.1 mmol, 10 mol %) are introduced into a 2 necks Schlenk-type flask, provided with a magnetic stirring bar and topped by a coolant then 10 ml of distilled THF are added. Triethylamine (59 mg, 1 mmol) and pinacolborane (0.384 g, 3 mmol) are introduced therein. 0.185 g, 1 mmol of (1-bromo-ethyl)benzene dissolved into 10 ml of distilled THF is then added drop by drop in the solution using a dropping funnel. Thereafter, the reactive mixture is stirred for approximately 15 hours at 0° C.

At the end of the reaction, the crude reaction product is hydrolyzed by 20 ml of water neutral and extracted by diethyl ether (3×40 ml). The joined organic phases are washed by 2×50 ml of neutral water then dried on MgSO₄. After solvent evaporation, pinacol ester is obtained with a yield of 30% and a conversion of 40% of the starting bromide (yield/conversion of 75%). The obtained boronic ester is analyzed by GC, NMR ¹H and ¹³C and GC/MS.

### Characterizations

NMR 7.3-7.1 (5H, m); 2.4 (1H, Q, 7.5 Hz); 1.3 (3H, D, 7.5 Hz); 1.2 (12H, S).

NMR ¹³C, 140.2; 128.7; 127.9; 126.2; 83.9; 30.8; 21.4; 9.4.

Mass spectrometry: 232-231 (M+, 26-10%); 217-216 (13-5%); 132 (30%); 117 (21%); 116-115 (10-3%); 106 (21%); 105-106 (96-29%); 103 (13%); 85 (57%); 84 (36%); 83 (100%); 77 (18%); 59 (13%).

### Example 10

### Preparation of pinacol ester of benzylboronic acid

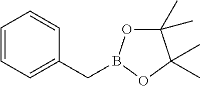

The magnesium turnings (2.4 mg, 0.1 mmol, 10 mol %) are introduced into a 2 necks Schlenk-type flask, provided with a magnetic stirring bar and topped by a coolant then 10 ml of distilled DEE (diethoxyethane) are added. Triethylamine (59 mg, 1 mmol) and pinacolborane (0.384 g, 3 mmol) are introduced therein. Benzyl chloride (0.127 g, 1 mmol) dissolved into 10 ml of distilled DEE is then added drop by drop in the solution using a dropping funnel. Thereafter, the reactive mixture is stirred for approximately 24 hours at DEE reflux (121° C.).

At the end of the reaction, the crude reaction product is hydrolyzed by 20 ml of neutral water and extracted by diethyl ether (3×40 ml). The joined organic phases are washed by 2×50 ml of neutral water then dried on MgSO₄. After solvent evaporation, pinacol ester is obtained with a yield of 42% and a conversion of 42% of the starting chloride (yield/conversion of 100%). The obtained boronic ester is analyzed by GC, NMR ¹H and ¹³C and GC/MS.

### Characterizations: See Example 5

### II. Preparation of Boronic Esters in the Presence of Magnesium Powder

Example 11 was carried out with magnesium powder.

The magnesium powder used is available from Alfa Aesar (+99%, 325 mesh). It is used as is without any prior manipulation.

### Example 11

### Preparation of pinacol ester of 4-methylbenzylboronic acid

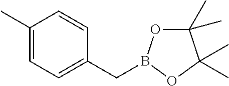

The magnesium powder (2.4 mg, 0.1 mmol, 10 mol %) is introduced into a 2 necks Schlenk-type flask, provided with a magnetic stirring bar and topped by a coolant then 10 ml of distilled THF are added. Triethylamine (59 mg, 1 mmol) and pinacolborane (0.384 g, 3 mmol) are introduced therein. 0.185 g, 1 mmol of 4-methylbenzyl bromide dissolved into 10 ml of distilled THF is then added drop by drop in the solution using a dropping funnel. Thereafter, the reactive mixture is stirred for approximately 9 hours at THF reflux (65° C.).

At the end of the reaction, the crude reaction product is hydrolyzed by 20 ml of water neutral and extracted by diethyl ether (3×40 ml). The joined organic phases are washed by 2×50 ml of neutral water then dried on MgSO₄. After solvent evaporation, pinacol ester is obtained with a yield of 67% and a conversion of 94% of the starting bromide (yield/conversion of 71%). The obtained boronic ester is analyzed by GC, NMR ¹H and ¹³C and GC/MS.

### Characterizations: See Example 5

### III. Preparation of Boronic Esters in the Presence of Magnesium Bar

Examples 12 and 13 were carried out with magnesium bar.

The magnesium bar used is available from Strem (Strem 99.8%, 454 g/rod; 33 mm diam. 305 mm long).

Two types of activation were used for the magnesium bar. This is described in the following example.

### Example 12

### Preparation of pinacol ester of 4-methylbenzylboronic acid

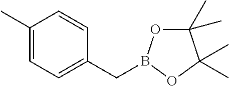

Initially, the bar is pickled electrochemically. In an electrochemical cell provided with a nickel foam cathode and with a magnesium anode (“shining” bar), distilled THF/DMF, a small amount of support electrolyte, (CF₃SO₂)₂NLi (1.4 mmol, 7.10⁻² M), and dibromoethane (1 mmol, 5.10² M) are disposed. To this cell, a constant intensity of 60 mA is applied. Thus, the reduction of ethylene dibromide into ethylene is obtained after the passage of 2 F/mol. The solution is taken. The bar is rinsed with a solution of distilled THF. Thus, the “activated” bar can be used as a new source of magnesium.

Thereafter, 10 ml of THF are disposed into a monopartitioned cell topped by a coolant and provided with a magnetic stirring bar. Triethylamine (59 mg, 1 mmol) and pinacolborane (0.384 g, 3 mmol) are introduced therein. 0.185 g, 1 mmol of 4-methylbenzyl bromide dissolved into 10 ml of THF is added drop by drop using a dropping funnel. The reactive mixture is stirred for approximately 13 hours at THF reflux (65° C.). At the end of the reaction, the crude reaction product is hydrolyzed by 20 ml of neutral water and extracted by diethyl ether (3×40 ml). The joined organic phases are washed by 2×50 ml of neutral water then dried on MgSO₄. After solvent evaporation, pinacol ester is obtained with a yield of 66% and a conversion of 92% of the starting bromide (yield/conversion of 72%). The obtained boronic ester is analyzed by GC, NMR ¹H and ¹³C and GC/MS.

### Characterizations: See Example 5

### Example 13

### Preparation of pinacol ester of 4-methylbenzylboronic acid

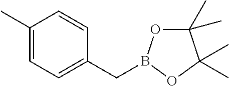

A “shining” bar may also be used. The bar is dipped into a solution of acid water (HCl, 0.1 M), is rinsed with water, acetone then put in a drying oven for drying.

With regard to the boration of 4-methylbenzyl bromide, the operating process is that described in example 11 and under these conditions the finished product is obtained with a yield of 85% and a total conversion of the starting bromide after 10 hours (yield/conversion of 85%).

### Characterizations: See Example 5

### IV. Preparation of Boronic Acids in the Presence of Magnesium Turnings

### Example 14

### Preparation of 4-methylbenzylboronic acid

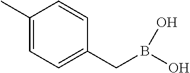

Magnesium turnings (2.4 mg, 0.1 mmol, 10 mol %) are introduced into a 2 necks Schlenk-type flask, provided with a magnetic stirring bar and topped by a coolant then 10 ml of distilled THF are added therein. Triethylamine (59 mg, 1 mmol) and catecholborane (0.120 g, 3 mmol) are introduced therein. 0.185 g, 1 mmol of 4-methylbenzyl bromide dissolved into 10 ml of distilled THF is then added drop by drop in the solution using a dropping funnel. Thereafter, the reactive mixture is stirred for approximately 40 hours at THF reflux (65° C.).

At the end of the reaction, THF is evaporated under vacuum before extraction. The solution is then acidified by an aqueous solution of hydrochloric acid 0.1 M (until obtaining a pH of 1) then extracted with diethyl ether (3×50 ml). The organic phase is dried on MgSO₄. The extraction solvent is evaporated under vacuum. After evaporation of the solvent, the boronic acid is obtained with a yield of 45% and a conversion of 53% (yield/conversion of 85%). The boronic acid is analyzed by GC, NMR ¹H and ¹³C and GC/MS.

### Characterizations:

NMR ¹H, 7.1 (4H, s); 2.29 (3H, s); 2.26 (2H, s).

NMR ¹³C, 134.6; 133.1; 127.8; 82.3; 33.7.

Mass spectrometry: 232-231 (M+, 65-19%); 217 (29%); 174 (16%); 146 (56%); 133 (41%); 132 (89%); 131 (37%); 117 (15%); 106 (28%); 15.105-104 (100-20%); 103 (16%); 92 (16%); 91 (64%); 86 (15%); 85 (83%); 84 (40%); 83 (93%); 82 (14%); 79 (22%); 78 (23%); 77-76 (38? 9%); 69 (21%); 67 (10%); 59 (34%); 57 (24%); 55 (26%); 53 (15%); 51 (15%).

The process of the invention makes it possible to obtain benzylboronic esters and acids with a yield ranging from 62 to 92% from benzyl bromides. This process also allows the benzyl chloride functionalization into benzylboronic ester and acid with a yield ranging from 92 to 100% and a conversion rate of the starting chlorides of about 40%.

The use of magnesium metal in the process of the invention makes it possible to carry out the boration reaction of the compounds of formula (II), under soft conditions, by avoiding the addition of transition metal complexes like Pd or Rh. Moreover, magnesium is not an expensive metal, is abundant and not toxic.

### V. Preparation of Boronic Acids and Esters on a Larger Scale

The process for preparing benzylboronic esters and acids according to the invention was carried out on a larger scale. The boration of 4-methyl benzyl bromide and benzyl bromide was carried out according to the operating processes described in examples 6, 7, 11, 13 and 14 by using 7 g of brominated compound and 10 mol. % of magnesium. The obtained yields range from 75 to 90%. Yields comparable to these are obtained for the same reactions at 20 to 100 g levels.

VI. Measurements of Stabilities for Benzylboronic Esters

The stability of two boronic esters (pinacol ester of 4-methylbenzylboronic and pinacol ester of benzylboronic prepared according to examples 11 and 6 respectively) was studied during ten weeks as a function of temperature, solvent, concentration, light and atmosphere (air/nitrogen).

Thirty samples were prepared and a follow-up of the benzylboronic ester concentration was carried out by gas chromatography in the presence of dodecane as the internal standard.

The list of the samples is presented in tables 1 and 2.

TABLE 1
Description of samples 1 to 7 with 4-methyl
benzylboronic pinacol ester in the presence of dodecane as the
internal standard.

| Sample | Solvent | Concentration | T (° C.) | Air-N₂ | Luminosity |
|---|---|---|---|---|---|
| 1 | acetone | 10 g/L | 20° C. | Air | light |
| 1′ | ethanol | 10 g/L | 20° C. | Air | light |
| 2 | acetone | 10 g/L | 20° C. | Air | dark |
| 2′ | ethanol | 10 g/L | 20° C. | Air | dark |
| 3 | acetone | 10 g/L | 4° C. | Air | light |
| 3′ | ethanol | 10 g/L | 4° C. | Air | light |
| 4 | acetone | 10 g/L | 20° C. | N₂ | light |
| 4′ | ethanol | 10 g/L | 20° C. | N₂ | light |
| 5 | acetone | 10 g/L | 20° C. | Air | dark |
| 5′ | ethanol | 50 g/L | 20° C. | Air | dark |
| 6 | — | — | 38° C. | Air | dark |
| 7 | — | — | 140° C. | Air | dark |

TABLE 2
Description of samples 11 to 17 with benzylboronic
pinacol ester in the presence of dodecane as the internal
standard.

| Sample | Solvent | Concentration | T (° C.) | Air-N₂ | Luminosity |
|---|---|---|---|---|---|
| 11 | acetone | 10 g/L | 20° C. | Air | light |
| 11′ | ethanol | 10 g/L | 20° C. | Air | light |
| 12 | acetone | 10 g/L | 20° C. | Air | dark |
| 12′ | ethanol | 10 g/L | 20° C. | Air | dark |
| 13 | acetone | 10 g/L | 4° C. | Air | light |
| 13′ | ethanol | 10 g/L | 4° C. | Air | light |
| 14 | acetone | 10 g/L | 20° C. | N₂ | light |
| 14′ | ethanol | 10 g/L | 20° C. | N₂ | light |
| 15 | acetone | 50 g/L | 20° C. | Air | dark |
| 15′ | ethanol | 50 g/L | 20° C. | Air | dark |
| 16 | acetone | — | 38° C. | Air | dark |
| 17 | ethanol | — | 140° C. | Air | dark |

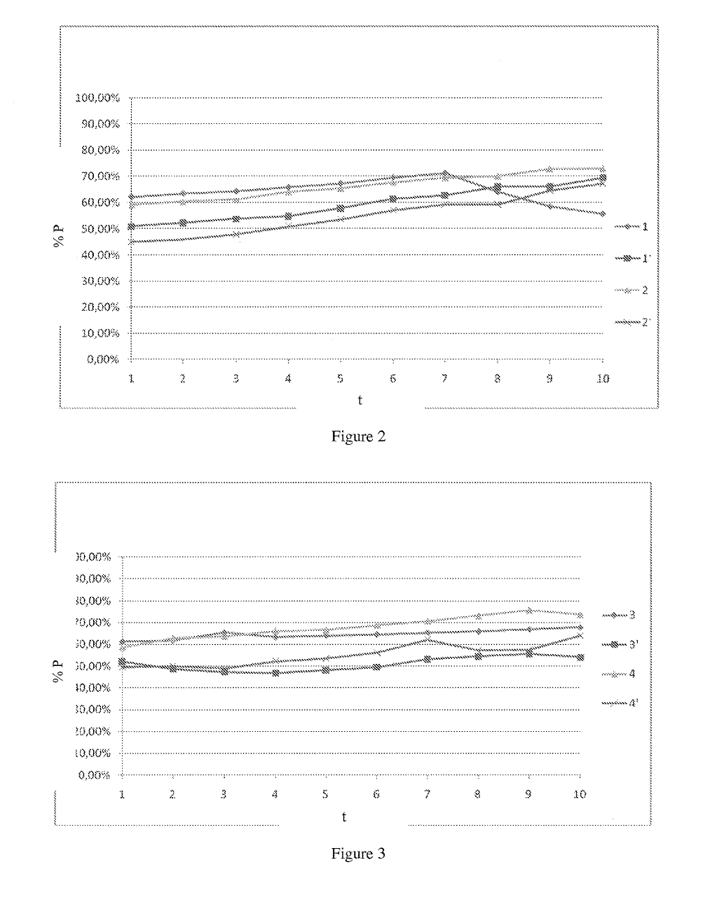

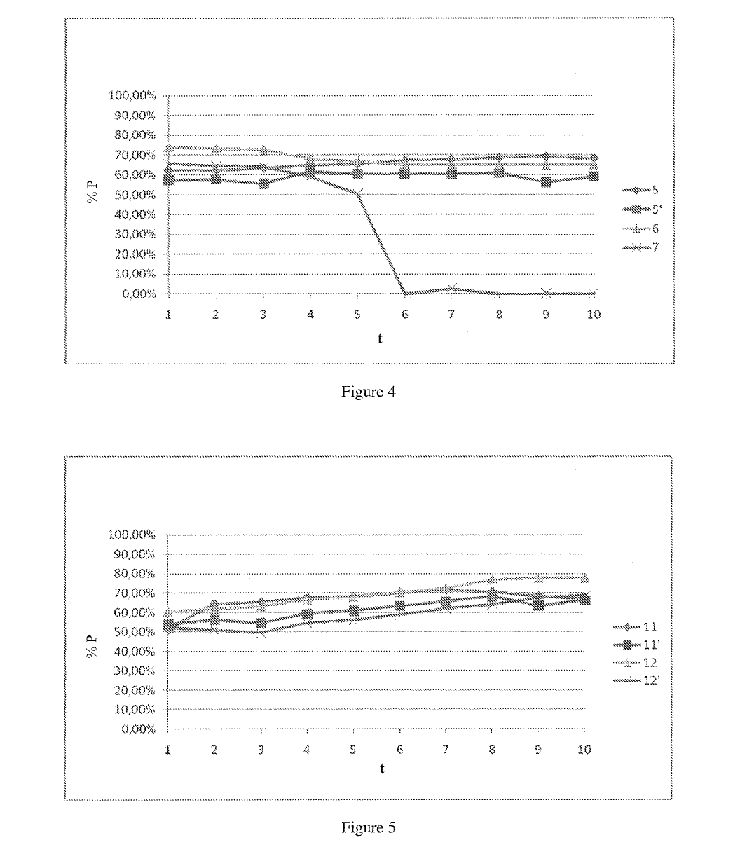

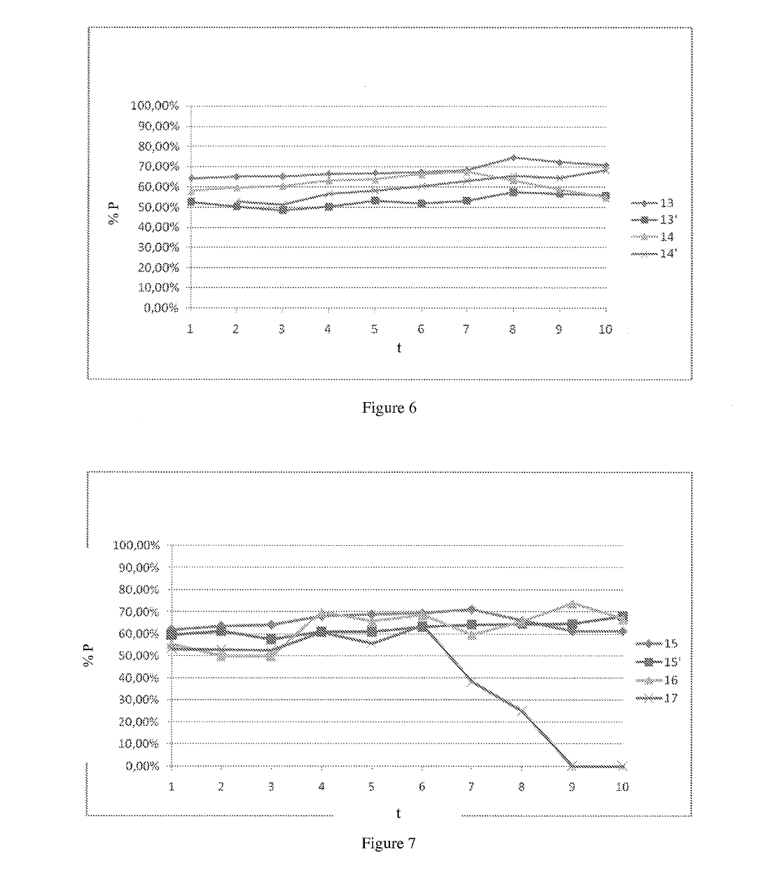

The curves reflecting the stability of these various samples are presented on FIGS. 2 to 7.

It can be observed that both benzylboronic esters offer a very good stability under all conditions, except when they are maintained at 140° C. without solvent and under air (curves 7 and 17). At 140° C., a degradation is observed after 5 to 6 weeks. Under all other conditions, in ethanol, acetone, or without solvent, from 4 to 38° C., under air or nitrogen, exposed to light or in the dark, both benzylboronic ester samples showed a perfect chemical stability during the 10 weeks of analysis. Their stability is certainly ensured beyond this period.

### LIST OF REFERENCES

[1] Hall, D. G. Boronic acids; 1. Ed; Wiley-VCH: Weinheim, 2006.
[2] Miyaura, N; Yanagi, T; Suzuki, A; The palladium-catalyzed cross-coupling reaction of phenylboronic acid with haloarenes in the presence of bases. Synth. Commun. 1981, 11(7), 513-519.
[3] Suzuki, A. recent advances In the cross-coupling reactions of organoboron derivatives with organic electrophiles, 1995-1998. J. Organometal. Chem. 1999, 576 (1-2), 147-168.
[4] Lappert, M. F. Chem. Rev., 1956, 56, 959, 1064.
[5] Letsinger, R. L.; Pietruska, J. An improved synthesis of functionalized biphenyl-based phosphine ligands. J. Am. Chem. Soc., 1959, 81, 3013-3017.
[6] Laza, C.; Dunach, E.; Serein-Spirau, F.; Moreau, J. J. E.; Vellutini, L. Novel synthesis of arylboronic acids by electroreduction of aromatic halides in the presence of trialkyl borates. New J. Chem., 2002, 26 (4), 373.
[7] Laza, C.; Dunach, E.; New electrosynthesis of arylboronic esters from aromatic halides and pinacolborane. Adv. Synth. Catal., 2003, 345 (5), 580.
[8] Laza, C.; Pintaric, C.; Olivero, S.; Dunach, E., Electrochemical reduction of polyhalogenated aryl derivatives in the presence of pinocolborane: Electrosynthesis of functionalised arylboronic esters. Electrochim. Acta., 2005, (50), 4897-4901.
[9] Pintaric, C.; Laza, C.; Olivero, S.; Dunach, E., Electrosynthesis of benzylboronic acids and esters. Tetrahedron Letters, 2004, 45 (43), 80-31-8033.
[10] Griesbach, U.; Elsner, O. Process for electrochemical preparation of alkylboronic acids and esters. DE A2 1621541, 2006.
[11] Murata, M.; Oyama, T; Watanabe, S., Masuda, Y. Synthesis of benzylboronates via palladium-catalyzed borylation of benzyl halides with pinacolborane. Synth. Commun., 2002, 32(16), 2513-2517.
[12] Giroux, A. Synthesis of benzylic boronates via palladium-catalyzed cross-coupling reaction of bis(picanolato)diboron with benzylic halides. Tetrahedron Lett., 2002, 44 (2), 233-235.
[13] Ishiyama, T; Oohashi, Z.; T. A.; Miyaura, N. Nucleophilic borylation of benzyl halides with bis(pinacolato)diboron catalyzed by palladium (0) complexes. Chem. lett, 2002, 31 (8), 780-781.
[14] Shimada, S.; Batsanov, A S.; Howard, J. A. K.; Marder, T. B. Formation of aryl- and benzylboronate esters by rhodium-catalyzed C—H bond functionalization with pinacolborane. Angew. Chem., Int. Ed., 2001, 40 (11), 2618-2171
[15] Mertins, K.; Zapf, A.; Beller, M. Catalytic borylation of o-xylene and heteroarenes via C—H activation. J. Mol. Catal. A-Chem.,2004, 207 (1), 21-25.
[16] Ishiyama, T.; Ishida, K., Takagi, J.; Miyaura, N. Palladium-catalyzed benzylic C—H borylation of alkylbenzenes with bis(pinacolato)diboron or pinacolborane. Chem. Lett., 2001, 30 (11), 1082-1083.
[17] Dietz, Rainer; Emmel, Ute; Wietelmann, Ulrich; Lischka, Uwe. Activation of alkaline earth metal, in particular, magnesium, for the preparation of organoalkaline earth metal compounds, WO 2007026016 A1.
[18] Rieke, Reuben D.; Sell, Matthew S., Magnesium activation (for Grignard reagent preparation). Chemical Industries (Dekker) (1996), 64 (Handbook of Grignard reagents), 53-77. CODEN: CHEIDI ISSN: 0737-8025. CAN 125: 195737 AN 1996:510697
[19] Jubault, Philipe; Feasson, Christian; Collignon, Noel, Magnesium activation by electrochemistry. Application to the synthesis of gem-difluoroalkenes by an electrochemical Witting reaction. Bulletin de la Société Chimique de France (1995), 132 (8), 850-6. CODEN: BSCFAS ISSN: 0037-8968. CAN 124: 117432 AN 1995:915784

1. A process for preparing a boronic acid or ester of formula (I): 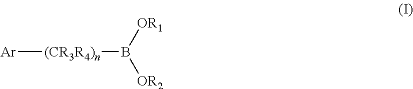
in which
Ar represents a mono- or poly-cyclic, fused or non-fused, aryl radical including 6 to 27 carbon atoms or a mono- or poly-cyclic, fused or non-fused, heteroaryl radical including 6 to 20 carbon atoms, said aryl or heteroaryl radical being optionally substituted by one or more groups independently selected from the group including (C₁-C₁₀)alkyl, (C₂-C₁₀)alkene, (C₂-C₁₀)alkyne, (C₃-C₁₀)cycloalkyl, (C₁-C₁₀)heteroalkyl, (C₁-C₁₀)haloalkyl, (C₆-C₁₂)aryl, F, Cl, Br, I, —NO2, —CN, —CF₃, —CH₂CF₃, —OH, —CH₂OH, —CH₂CH₂OH, —NH₂, —CH₂NH₂, —NHCHO, —COOH, —CONH₂, —SO₃H, —O(SO)₂—R₅ where R₅ is (C₁-C₁₀) alkyl, —PO₃H, —PO₃R₁,
n=0 to 1;
R₁, R₂, R₃ and R₄, same or different, represent a hydrogen atom, a (C₁-C₁₀)alkyl group, a mono- or poly-cyclic, fused or non-fused, aryl radical including 6 to 27 carbon atoms, a mono- or poly-cyclic, fused or non-fused, heteroaryl radical including 6 to 20 carbon atoms, said radical and group being optionally substituted by one or more groups independently selected from the group including (C₁-C₁₀)alkyl, (C₁-C₁₀) alkoxy, (C₂-C₁₀)alkene, (C₂-C₁₀)alkyne, (C₃-C₁₀)cycloalkyl, (C₁-C₁₀) heteroalkyl, (C₁-C₁₀) haloalkyl, (C₆-C₁₂)aryl, F, Cl, Br, I, —NO₂, —CN, —CF₃, —CH₂CF₃, —OH, —CH₂OH, —CH₂CH₂OH, —NH₂, —CH₂NH₂, —NHCHO, —COOH, —CONH₂, —SO₃H, —O(SO)₂—R₅ where R₅ is (C₁-C₁₀)alkyl, —PO₃H, —PO₃R₁; or
R₁ and R₂ form with the oxygen atoms to which they are bonded, a 5 or 6 links ring optionally substituted by one or more groups independently selected from the group including a (C₁-C₁₀)alkyl group, a mono- or poly-cyclic, fused or non-fused, aryl radical including 6 to 27 carbon atoms, a mono- or poly-cyclic, fused or non-fused, heteroaryl radical including 6 to 20 carbon atoms said radical and group being substituted by one or more groups independently selected from the group including (C₁-C₁₀)alkyl, (C₂-C₁₀)alkene, (C₂-C₁₀)alkyne, (C₃-C₁₀)cycloalkyl, (C₁-C₁₀) heteroalkyl, (C₁-C₁₀)haloalkyl, (C₆-C₁₂)aryl, F, Cl, Br, I, —NO₂, —CN, —CF₃, —CH₂CF₃, —OH, —CH₂OH, —CH₂CH₂OH, —NH₂, —CH₂NH₂, —NHCHO, —COON, —CONH₂, —SO₃H, —O(SO)₂—R₅ where R₅ is (C₁-C₁₀)alkyl, —PO₃H, —PO₃R₁;
in which a compound of formula (II):
Ar—(CR₃R₄)n-X (II)
in which Ar, R₃, R₄ and n are such as previously defined and X is selected from the group including F, Cl, Br, I, —CF₃, —O(SO)₂CF₃, —O(SO)₂—R₅ with R₅ being (C₁-C₁₀) alkyl;
is reacted with a borating agent and in the presence of magnesium metal (Mg⁰) used in an amount from 0.01 to 1 equivalent, with respect to the amount of the compound of formula (II).

2. A process according to claim 1, wherein the compound of formula (II) selected from the group comprising:
benzyl bromide or chloride; 4-methylbenzyl bromide or chloride; 4-methoxybenzyl bromide or chloride;
2-methylbenzyl bromide; 3,5-dimethylbenzyl bromide; 4-tertbutylbenzyl bromide; (2-bromoethyl)benzene; 4-chlorobenzyl bromide; 4-bromobenzyl bromide.
4-ethylbenzene iodide; 2-methylbenzene bromide; 4-butylbenzene bromide; 4-methylnaphthalene bromide; 3,4-difluorobenzene bromide.

3. A process according to one of claim 1 or 2, wherein the borating agent is of formula (III): 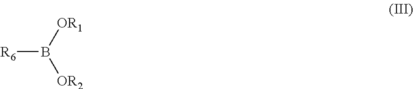
in which R₁ and R₂ are such as previously defined and R₆ represents a hydrogen atom.

4. A process according to claim 3, wherein the borating agent of formula (III) is selected from the group including pinacolborane (HBpin), catecholborane (HBcat).

5. A process according to one of claim 1 or 2, wherein the borating agent is of formula (IV): 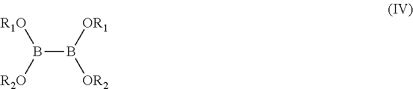
in which R₁ and R₂ are such as previously defined.

6. A process according to claim 5, wherein the borating agent of formula (IV) is selected from the group including bis(pinacolyl)diboron (pinB-Bpin).

7. A process according to one of claim 1 or 2, wherein the borating agent is a boron hydride of formula (V):
BxHyQz (V)
in which
Q is an alkaline metal selected from the group including Li, Na, K, or Q is R₁ such as previously defined,
x is an integer ranging between 1 and 10,
y is an integer ranging between 3 and 14, and
Z=0 to 3,
given that when Z=0, the boron hydride is optionally in the form of a complex.

8. A process according to claim 7, wherein the borating agent of formula (V) is selected from the group including BH₃.S (CH₃)₂, BH₃.THF, NaBH₄.

9. A process according to claim 1, wherein the reaction between the compound of formula (II) and the borating agent, takes place in one organic solvent or a mixture of organic solvents in the presence of a base.

10. A process according to claim 1, wherein the magnesium metal (Mg⁰) is in the form of turnings, powder or bar.

11. A process according to claim 1, wherein the magnesium metal (Mg⁰) is activated through a processing using an acid or through an ultrasound processing.

12. A process according to claim 1, wherein the borating agent is used in stoechiometric amounts, with respect to the amount of the compound of formula (II).

13. A process according to claim 1, wherein the magnesium metal (Mg⁰) is used in an amount ranging from 0.02 to 0.5 equivalent, with respect to the amount of the compound of formula (II).

14. A process according to claim 1, wherein the magnesium metal (Mg⁰) is used in an amount ranging from 0.01 to 0.2 equivalent, with respect to the amount of the compound of formula (II).

15. A process according to claim 9, wherein the base is selected from the group including triethylamine (NEt₃), potassium tert-butylate(t-BuOK), 2,6-di-tert-butylpyridine, tributylamine, tripropylamine, triisopropylamine.

16. A process according to claim 15, wherein the base is used in a stoechiometric amount, with respect to the amount of the compound of formula (II).

17. A process according to claim 9, wherein the solvent is selected from the group including diethyl ether, tetrahydrofuran (THF), methoxybenzene (anisole), ethanediol (ethylene glycol), N,N-dimethylformamide (DMF), acetonitrile or a mixture thereof.

18. A process according to claim 1, wherein the reaction between the compound (II) and the borating agent takes place at a temperature from 0° C. to the reflux temperature of the solvent or mixture of solvents.

19. A process according to claim 1, wherein the duration of the reaction may range from 1 to 48 hours.

20. (canceled)
